(19) United States
(12) Patent Application Publication
(10) Pub. No.: US 2026/0249352 A1
(43) Pub. Date: Aug. 27, 2026

(54) Producing Rotationally Symmetric Magnetic Sheets

(71) Applicant: Siemens Aktiengesellschaft, München (DE)

(72) Inventors: Rolf Vollmer, Gersfeld (DE); Gotthard Rieger, München (DE)

(73) Assignee: Siemens Aktiengesellschaft, München (DE)

(21) Appl. No.: 18/854,886

(22) PCT Filed: Mar. 2, 2023
(86) PCT No.: PCT/EP2023/055329

§ 371 Date: Oct. 7, 2024

(30) Foreign Application Priority Data
Apr. 8, 2022 (EP) 22167377.5

(51) Int. Cl. B22F 5/00; B22F 1/10; B22F 3/16; B22F 3/24; B22F 5/08

(52) U.S. Cl. CPC B22F 5/006; B22F 1/10; B22F 3/164; B22F 3/24; B22F 5/08; B22F 2003/248; B22F 2301/35

(57) ABSTRACT

Various embodiments of the teachings herein include a method for producing a rotationally symmetrical magnetic sheet having a plurality of radially running winding teeth for a laminated core of an electric machine. An example includes: producing a green body by applying a printing paste onto a substrate using a stencil printing method, wherein the printing paste comprises binders and iron particles having more than 95 wt. % of iron; producing a preform from the green body using a first thermal treatment wherein the binders are removed from the green body; producing the magnetic sheet from the preform using a second thermal treatment including a sintering process; and pressing the magnetic sheet with a pressure of more than 5 MPa in a uniaxial manner in the sheet plane thereof with a pressing ram. The pressing generates an anisotropic texture in the winding teeth.

### CROSS-REFERENCE TO RELATED APPLICATIONS

This application is a U.S. National Stage Application of International Application No. PCT/EP2023/055329 filed Mar. 2, 2023, which designates the United States of America, and claims priority to EP Application No. 22167377.5 filed Apr. 8, 2022, the contents of which are hereby incorporated by reference in their entirety.

### TECHNICAL FIELD

The present disclosure relates to electric machines. Various embodiments of the teachings herein include systems and/or methods for producing rotationally symmetric magnetic sheets.

### BACKGROUND

Electric machines, in particular electric motors, have a rotor mounted on a shaft with a laminated core that is wrapped with corresponding windings. The laminated core comprises individual soft magnetic laminations, which in conventional motors are generally punched out of sheet metal strips and stacked to form a laminated core. For modern high-performance engines, additively manufactured sheets produced using stencil printing methods, for example, are sintered and similarly stacked to form a laminated core. Such printed sheets allow soft magnetic materials to be used in order to generate very good soft magnetic properties.

However, the sintering processes used may lead to isotropic crystal growth, which in turn has a rather negative effect on the coercive field strength in the preferred directions of the sheet plane. For low frequencies, the magnetic sheet must have the lowest possible magnetic hysteresis losses and therefore a low coercive field strength in the direction of flux.

### SUMMARY

The teachings of the present disclosure include systems and methods for producing magnetic sheets, laminated cores formed therefrom, and electric machines which, compared to the state of the art, in particular stamped magnetic sheets and printed and sintered magnetic sheets, have very good soft magnetic properties on the one hand and, in particular in the areas in which a magnetic flux occurs, comprise a very low coercive field strength. For example, some embodiments of the teachings herein include a method for producing a rotationally symmetrical magnetic sheet (2) of a laminated core (4) of an electric machine (6), having a plurality of radially running winding teeth (8), comprising: producing a green body (10) by applying a printing paste (12) onto a substrate (14) using a stencil printing method (16), wherein the printing paste (12) comprises binders and iron particles, and the iron particles comprise more than 95 wt. % of iron, a first thermal treatment (18), wherein the binders are removed from the green body (10), thus producing a preform (20), a second thermal treatment (22) of the preform (20) in the form of a sintering process to produce the magnetic sheet (2), characterised in that the magnetic sheet (2) is pressed with a pressure of more than 5 MPa in a uniaxial manner in the sheet plane (26) thereof by means of a pressing ram (28) and an anisotropic texture 34 is generated in the winding teeth 8 in the radial extension by means of the uniaxial pressing.

In some embodiments, a third thermal treatment (32) takes placed following the uniaxial pressing in the form of a recrystallization annealing.

In some embodiments, during the recrystallization annealing a temperature of between 600° C. and 800° C. is constantly maintained for a time of at least 8 minutes.

In some embodiments, along the radial extension of the winding teeth an anisotropic magnetic texture (34) is created.

In some embodiments, along the radial extension of the winding teeth a Goss texture is created.

In some embodiments, the grains of the texture (34) have an average diameter in an image plane of 80 μm to 400 μm.

In some embodiments, by means of the stencil printing method (16) the thickness of the green body (10) is set in a range of 100 μm to 400 μm, which results in a thickness of the magnetic sheet (2) that is in a range between 100 μm and 300 μm.

In some embodiments, the thickness (42) of the magnetic sheet is set between 150 μm and 250 μm.

In some embodiments, the iron particles have an iron content of more than 97 wt. %, e. g. more than 99 wt. %.

In some embodiments, pressing ram (28) is rotated by an angle α of less than 10° in particular less than 3°, and at least 0.5°, during the pressing process.

### BRIEF DESCRIPTION OF THE DRAWINGS

Further embodiments of the teachings herein and further features are described in the following special description by means of the figures. These are purely exemplary, schematically illustrated embodiments that do not represent any restrictions on the scope of protection. These show as follows:

FIG. 1 an exploded view of a conventional electric machine with a Roto and laminated core;

FIG. 2 a conventional laminated core consisting of several magnetic sheets with a plurality of winding teeth;

FIG. 3 a laminated core with magnetic sheets incorporating teachings of the present disclosure;

FIG. 4 a top view of a magnetic sheet incorporating teachings of the present disclosure;

FIG. 5 a schematic representation of the production process of a magnetic sheet incorporating teachings of the present disclosure;

FIG. 6 a representation of the magnetization when using different textures incorporating teachings of the present disclosure; and

FIG. 7 a schematic representation of a microstructure of a texture with direction indicators for different magnetic domains.

### DETAILED DESCRIPTION

The described methods and systems for producing a rotationally symmetrical magnetic sheet may be used to produce a magnetic sheet for a laminated core of an electric machine. The resulting magnetic sheet has a plurality of radially running winding teeth. An example method comprises:
Producing a green body by applying a printing paste onto a substrate using a stencil printing method, wherein the printing paste comprises binders and iron particles, and the iron particles comprises more than 95 wt. % of iron.
This is followed by a first thermal treatment, during which the binders are removed from the green body, thus producing a preform.
The preform then undergoes a second thermal treatment in the form of a sintering process to produce the magnetic sheet.
Subsequently, the magnetic sheet is pressed with a pressure of more than 5 MPa in a uniaxial manner in the sheet plane thereof by means of a pressing ram.

A magnetic sheet is produced which, due to the stencil printing method and the subsequent debinding or sintering process, uses materials which have particularly good soft magnetic properties compared to the conventional stamped magnetic sheets of the prior art and which may have a high iron content of at least 95% iron. In some embodiments, pure iron with very little contamination is used for this purpose. This printed and sintered magnetic sheet therefore differs from the prior art in terms of its soft magnetic properties.

Surprisingly, Uniaxial Pressing With a Pressure of at Least 5 Mpa in a pressure range up to about 50 MPa, in particular in the winding teeth in the radial direction, creates a crystal structure that positively influences the magnetic flux along this radial direction of the winding tooth and where very low hysteresis losses occur and thus also a low coercive field strength is present. Furthermore, uniaxial pressing improves the planarity of the magnetic sheet, which leads to a denser packing when stacked in a laminated core and thus also to a higher iron content by volume of the unit laminated core.

A green body is a molded body for subsequent heat treatment, which usually contains binders, including solvents, which serve to improve shaping. A green body is generally mechanically self-supporting and can withstand limited mechanical loads. A green body free of these binders and/or solvents is referred to in this context as a preform. The molded body contains only the functional components of the final body, which also actively participate in the sintering process. Heat treatment in the form of a sintering process, in which, unlike a melting process, individual grains in the preform form a coherent, materially connected structure through diffusion processes, transforms the preform into a sintered body. Once the sintering process has been carried out, the resulting body is referred to in this context as a magnetic sheet. However, this magnetic sheet can still be subjected to various finishing processes.

A stencil printing method is a method in which a printing paste is applied to a substrate, for example by means of a doctor blade, resulting in a layer that usually has a thickness in the range between 70 μm and 300 μm (in particular between 150 μm and 250 μm). The paste is only printed onto the substrate on certain uncovered areas that are kept free by means of a stencil. The paste is usually printed through a screen, but this is not necessary. Stencil printing using a screen is referred to as screen printing, which is why the screen printing method is conceptually subsumed under the stencil printing method.

In some embodiments, the method include carrying out a third thermal treatment in the form of recrystallization annealing after the pressing process described. This may be carried out in a temperature range between 600° C. and 800° C. The recrystallization annealing process may be carried out at a constant temperature for between at least 8 minutes and around 30 minutes. Recrystallization annealing is typically complete after 60 minutes at a constant temperature within the described temperature window. This annealing process favors the formation of a magnetically effective texture.

In some embodiments, there is an anisotropic magnetic texture along a radial extension of the winding teeth. This radial extension of the winding teeth is also the magnetic flux path in which the magnetic flux takes place and the soft magnetic properties with the lowest possible hysteresis losses should be present. A Goss texture may be particularly advantageous as a texture. However, a cubic texture is also expedient. The grains of the texture 34 may have an average diameter in an image plane of 80 μm to 400 μm.

In crystallography, texture refers to the entirety of the orientations of the crystallites of a multicrystalline solid. The orientation of a crystal can be determined by diffraction of an incident wave at the lattice planes. According to the Bragg equation, an angle can be assigned to an incident monochromatic radiation and the lattice parameter of the lattice plane. For example, the texture is made visible using polarized light in a Kerr microscope. This involves creating a micrograph of the magnetic sheet surface, which is analyzed under a microscope using image processing software. For example, both a Zeiss microscope and the ZEN software available for this purpose can be used for image processing. In the texture described here, more than 50% of the magnetically active domains have a preferred direction that deviates by less than 36° from the radial direction.

The Goss texture is a special type of magnetic sheet texture in which the cubic crystals of the iron crystal lattice lie in the sheet plane in the (110)-direction, with the cube edges of the cubic lattice essentially following the radial extension of the winding teeth as defined above. In the ideal case, the cube edges are aligned along the radius of the magnetic sheet. A cubic texture is also expedient, with the cube edges also ideally running along the radius but being oriented in the (100)-direction.

The grains of the texture have an average diameter in an image plane of 100 μm to 400 μm. In some embodiments, the grains have a thickness of between 40 and 80 μm, in particular around 60 μm.

The stencil printing method allows the thickness of the green body to be varied using parameters such as the doctor blade pressure and the quantity of paste. The thickness of the green body may be between 100 μm and 400 μm, which results in a thickness of a magnetic sheet after the second thermal treatment that is in a range between 100 μm and 300 μm. The thickness of the magnetic sheet may be between 150 μm and 250 μm. This means that the magnetic sheets are significantly thinner than conventionally punched sheets, punched sheets usually having a minimum thickness of 330 μm. It should be noted that eddy current losses during operation of the electric machine reduce quadratically as the thicknesses of the magnetic sheet become smaller. Thinner sheets therefore lead to lower eddy current losses in the electric machine. With punched sheets, sheet thicknesses of less than 330 μm cannot be achieved with reproducible high quality according to the prior art.

In some embodiments, the proportion of iron in the iron particles is as high as possible. This may be at least 95 wt. %, 97 wt. %, or even more than 99 wt. %. The higher the iron content, the better the magnetizability of the magnetic sheet. This increases the torque of an electric motor with low eddy current losses, giving the electric motor or electric machine better efficiency and energy performance.

In some embodiments, the pressing ram is rotated by an angle a of less than 10°, in particular less than 3°, and at least 0.5°, during the pressing process. In addition to the uniaxial pressure on the magnetic sheet, a shearing force is also applied in this way, so that a texture is also created in the circumferential direction of the magnetic sheet outside the winding teeth enclosed circumferential yoke.

Some embodiments include a rotationally symmetrical magnetic sheet for a laminated core of an electric machine. The magnetic sheet is characterized in that it has a thickness of between 100 μm and 250 μm and a sintered metallic phase comprising at least 95 wt. % of iron. The magnetic sheet also has a plurality of radially running winding teeth. A plurality of radial winding teeth is also provided along the radial extension of an anisotropic magnetic texture. The magnetic sheet described has the same advantages as those already described with respect to the magnetic sheet which can be produced by one or more of the methods described herein. The anisotropic magnetic texture, which is achieved in particular by uniaxial pressing of the magnetic sheet, results in particularly good soft magnetic properties of the magnetic sheet.

Some embodiments include a laminated core of an electric machine with a plurality of stacked magnetic sheets, which in turn are produced by one or more of the methods described herein. Some embodiments include an electric machine comprising a laminated core as described herein, where the electric machine may be an electric motor.

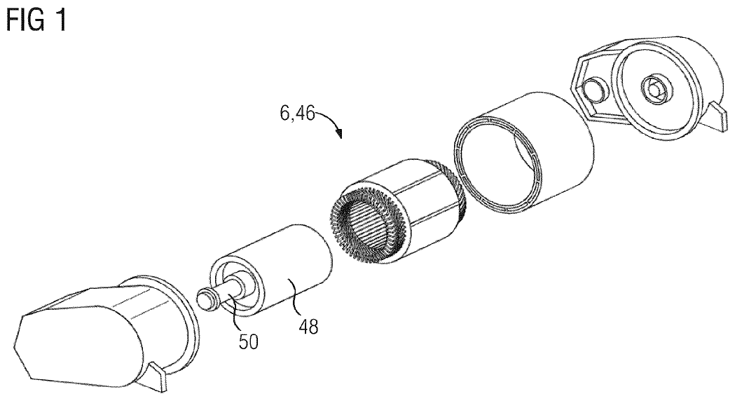

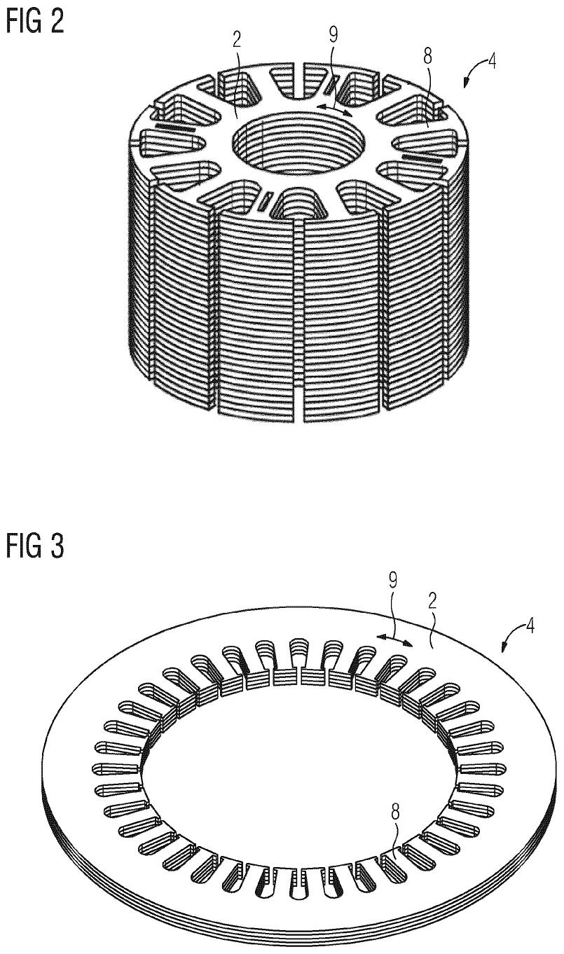

FIG. 1 shows an overview of a typical electric machine 6 in the form of an electric motor 46 in an exploded view. The representation serves to better position the components described below in terms of location. The electric machine 6 has a rotor 48 which is mounted on a shaft 50. FIG. 2 shows a laminated core 4 made up of a plurality of stacked magnetic sheets 2. This laminated core 4 is part of the rotor 48 shown in FIG. 1. The individual magnetic sheets 2 of the laminated core 4 have winding teeth 8 around which the electrical cables, which are not shown here, are wound. The winding teeth 8 in the laminated core 4 thus serve as a yoke for an electromagnet.

Another configuration of a laminated core 4 is shown in FIG. 3, where only four magnetic sheets 2 are stacked on top of each other, although there are usually significantly more magnetic sheets 2, as shown in FIG. 2. The magnetic sheets 2 according to FIG. 3 also have winding teeth 8, the magnetic sheet 2 also having a circumferential ring 9 into which the winding teeth 8 merge. The circumferential ring 9 in FIG. 3 is arranged in the outer area of the magnetic sheet 2; in the magnetic sheet 2 shown in FIG. 2, the circumferential ring 9 is arranged inside the magnetic sheet 2.

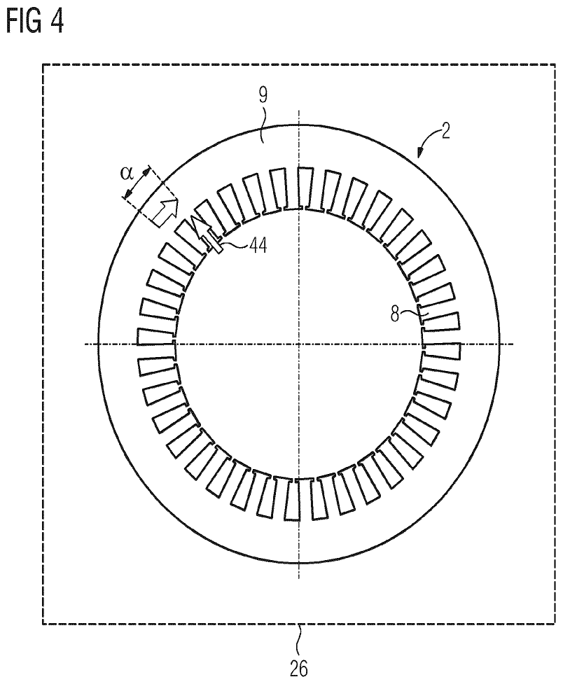

FIG. 4 shows a top view of a magnetic sheet 2, which corresponds approximately to that shown in FIG. 3. A radial extension 44 is shown here, which corresponds to a radius around the center of the rotationally symmetrical magnetic sheet 2. The winding teeth 8 are also arranged along a radius line. FIG. 4 also shows the sheet plane as a dashed line, which coincides with the image plane in this illustration. A second arrow in the circumferential ring 9 of the magnetic sheet 2 is labeled a; this angle will be discussed below.

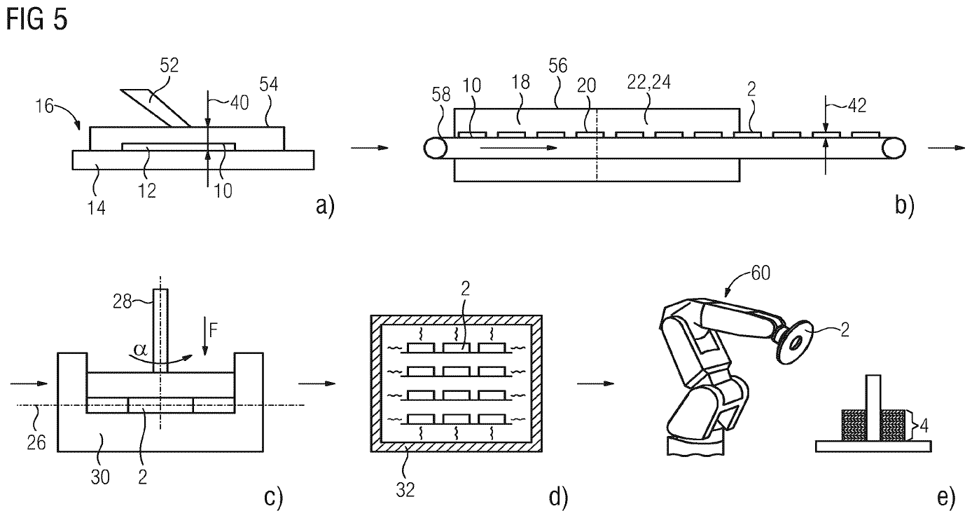

FIG. 5 schematically illustrates the production of a magnetic sheet 2 and then of a laminated core 4, as described in FIGS. 1 to 4. The description begins at the top left with the first sub-figure a, which illustrates a stencil printing method 16. Here, a printing paste 12 is printed onto a substrate 14 via a stencil 54, which is generally shown as a screen stencil, using a doctor blade 52. This creates a green body 10. The green body 10 usually has a thickness 40, which in this state is approx. 250 to 300 μm. The green body 10 contains the components of the printing paste 12. These are solvents, polymer binders and iron powders. The iron powders have the highest possible iron content, which should be over 95 wt. %. In particular, the iron content of the iron particles in the printing paste is over 99 wt. %, which is why this can already be considered pure iron.

The green body 10 is in itself mechanically self-supporting and stable, especially when it has been dried of solvents, to the extent that it can be subjected to a heat treatment process, as shown in FIG. 5. It is detached from the substrate 14 or, if the substrate is a flexible substrate 14, fed directly onto the substrate for the first heat treatment step 18 of the heat treatment. The first heat treatment step 18 is a debinding process in which the green body 10 may be dried, i.e. freed from solvents, and then heated to such an extent that the organic binders are also thermally decomposed.

FIG. 5b shows this procedure schematically as a continuous process in a tunnel kiln 56. In principle, it is also possible to carry out the individual procedures in batch furnaces in individual batches. However, in order to achieve the highest possible production efficiency it is advisable to use a tunnel kiln as shown here. During the first thermal treatment 18, i.e. the debinding process, temperatures of for example approximately 250° C. are applied, in some cases under inert gas.

The second part of the continuous furnace 56 is characterized by the second thermal treatment 22, which is carried out in the form of a sintering process 24. Here, the temperature is significantly increased compared to the first thermal treatment, being approximately 1,000° C. to 1,350° C. for sintering iron particles.

With regard to the phraseology, it should be noted that the green body 10 is still referred to as the green body 10 when it enters the furnace 56 or during the first thermal treatment, after the first thermal treatment it is referred to as the preform, which is fed to the sintering process 24, and after leaving the continuous furnace or after the sintering process in general, the preform 20 is referred to as the magnetic sheet 2. The magnetic sheet 2 has a thickness 42 of between 150 μm and 250 μm.

Furthermore, as shown in FIG. 5c, the magnetic sheet 2 is pressed uniaxially perpendicular to the sheet plane 26. The effect of this uniaxial pressing process in the uniaxial press 30 by means of the pressing ram 28 will be discussed later. It should be noted that the pressing ram 28 is pressed onto the magnetic sheet 2 with a force F that should be at least 5 MPa and generally does not need to be more than 50 MPa. Multiple uniaxial pressing, e.g. up to five-fold repetition of the pressing process, can be expedient for a particularly good formation of the desired texturing. It is also expedient to temper the magnetic sheet 2 during uniaxial pressing. This can take the form of hot pressing, for example, at a temperature between 100° C. and 300° C.

If necessary, the ram can be rotated by an angle a, which is less than 5°and is 1°, for example, in order to introduce shear forces into the magnetic sheet 2 in addition to the uniaxial forces F. It has been found that the described application of force has an effect on the crystalline structure of the magnetic sheet comparable to a rolling process, which was not to be expected due to the rather static nature of the application of force. A particular advantage here is that the uniaxial pressing also means that the magnetic sheet 2 is subjected to fewer shear forces than is the case with rolling.

In some embodiments, a recrystallization annealing according to FIG. 5d is carried out in a third thermal treatment 32. This third thermal treatment 32 is shown here schematically in the form of a batch furnace, but it can just as easily be carried out in a continuous s furnace 56, as in FIG. 5b. For recrystallization annealing 32, a temperature of 600° C. to 800° C., for example 620° C. or 720° C., can usually be applied constantly for between at least 8 minutes and approximately 30 minutes. This temperature treatment in this area leads to a further increased formation of an anisotropic texture in certain material areas of the magnetic sheet 2. The temperature is an influencing factor on the size of the crystal grains that form in the texture 34. The higher the recrystallization temperature, the larger the grains formed. The formation of larger grains (80-150 μm) inside the sheet and smaller grains (50-100 μm) on the surfaces may suppress anomalous eddy current losses.

The magnetic sheets 2 heat-treated in this way are now stacked to form a laminated core 4, for example using a robot arm 60 to automate the process. The laminated core 4 can be bonded in such a way that the individual magnetic sheets 2 are provided with organic coatings in particular and, if necessary, immersed in a bath of organic binders. This process is not described in more detail here.

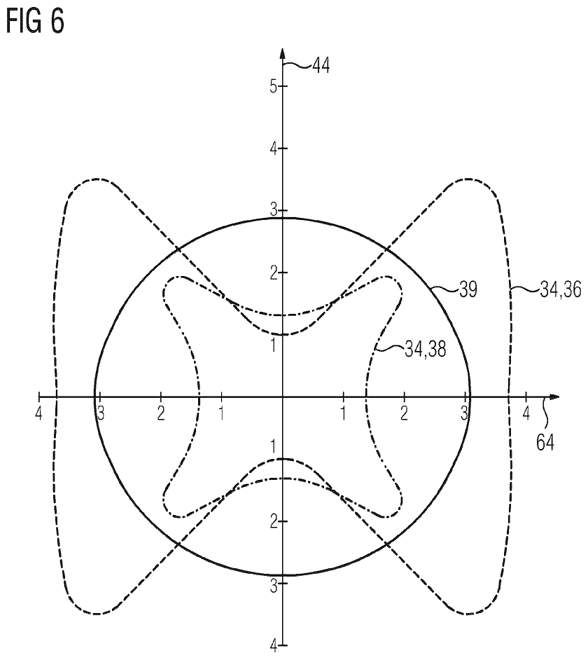

As already mentioned, an anisotropic texture 34 is produced by means of uniaxial pressing, in particular in the winding teeth 8 in radial extension 44. This texture 34 is also reinforced by recrystallization annealing, i.e. the third thermal treatment 32. In FIG. 6, the losses P_{1.5} at 50 Hz are plotted in the sheet plane 26 based on the extension along the winding teeth 8 in radial extension 44 and transversely thereto, in circumferential direction 64. The first texture 34 is a uniaxial Goss texture 36; if a second texture direction at 90° is added, this is referred to as a cubic texture 38. The circle 39 in FIG. 6 represents a purely isotropic texture 39. It can be seen here that the losses in radial extension 44 are significantly lower with a Goss texture 36 and a cubic texture 38 than with an isotropic material. It may be advantageous to introduce these textures 34, 36, 38 into the magnetic sheet 2 by the described uniaxial pressing and, if necessary, to reinforce them by the third thermal treatment 32, i.e. recrystallization annealing.

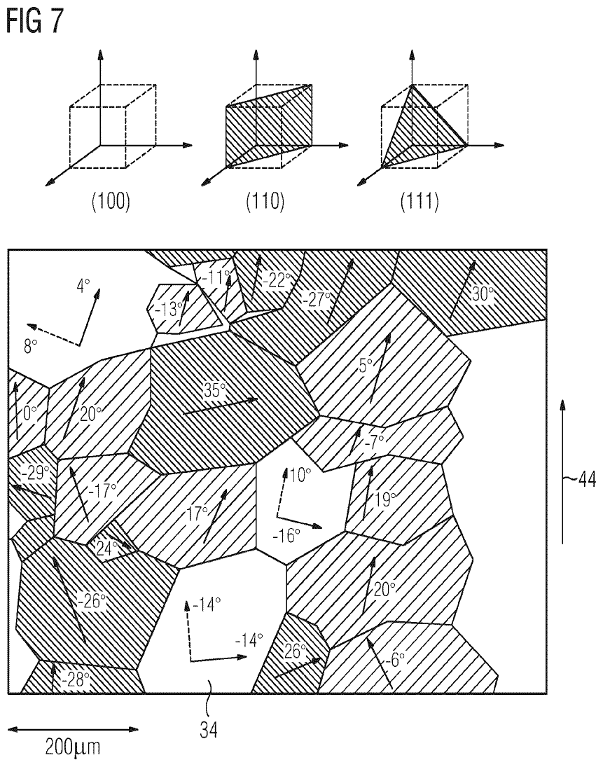

Textures 34 in general do not naturally lead to precisely aligned magnetic domains, but rather to preferred directions which, as shown in FIG. 7, are for the most part aligned with the radial extension 44. At least 50% of the individual grains should not deviate more than 36° from the preferred radial and tangential directions 44, as shown in FIG. 7 with the arrows and the angles. This would be referred to as an isotropic texture, which, as shown in FIG. 6, causes higher magnetic losses with respect to the preferred directions.

### LIST OF REFERENCE SIGNS

2 Magnetic sheet

4 Laminated core

6 Electric machine

8 Winding teeth

9 Circumferential ring

10 Green body

12 Printing paste

14 Substrate

16 Stencil printing method

18 First thermal treatment

20 Preform

22 Second thermal treatment

24 Sintering process

26 Sheet plane

28 Pressing ram

30 Uniaxial press

32 Third thermal treatment

34 Texture

36 Goss texture

38 Cubic texture

39 Isotropic texture

40 Thick green body

42 Thick magnetic sheet

α Angle

44 Radial extension

46 Electric motor

48 Rotor

50 Shaft

52 Doctor blade

54 Stencil

56 Continuous furnace

58 Conveyor belt

60 Robot arm

64 Circumferential direction

What is claimed is:

1-14. (canceled)

15. A method for producing a rotationally symmetrical magnetic sheet having a plurality of radially running winding teeth for a laminated core of an electric machine, the method comprising:
producing a green body by applying a printing paste onto a substrate using a stencil printing method, wherein the printing paste comprises binders and iron particles having more than 95 wt. % of iron;
producing a preform from the green body using a first thermal treatment wherein the binders are removed from the green body;
producing the magnetic sheet from the preform using a second thermal treatment including a sintering process; and
pressing the magnetic sheet with a pressure of more than 5 MPa in a uniaxial manner in the sheet plane thereof with a pressing ram;
wherein the pressing generates an anisotropic texture in the winding teeth.

16. The method as claimed in claim 15, further comprising annealing the magnetic sheet using a third thermal treatment following the uniaxial pressing providing a recrystallization annealing.

17. The method as claimed in claim 16, further comprising maintaining a temperature of between 600° C. and 800° C. for a time of at least 8 minutes during the recrystallization annealing.

18. The method as claimed in claim 15, wherein the anisotropic texture along the radial extension of the winding teeth includes an anisotropic magnetic texture.

19. The method as claimed in claim 18, wherein the texture along the radial extension of the winding teeth includes a Goss texture.

20. The method as claimed in claim 18, wherein the resulting grains have an average diameter in an image plane of 80 μm to 400 μm.

21. The method as claimed in claim 15, wherein:
the thickness of the green body is in a range of 100 μm to 400 μm; and
a thickness of the magnetic sheet is in a range between 100 μm and 300 μm.

22. The method as claimed in claim 21, wherein the thickness of the magnetic sheet is between 150 μm and 250 μm.

23. The method as claimed in claim 15, wherein the iron particles have an iron content of more than 97 wt. %.

24. The method as claimed in claim 15, further comprising rotating the pressing ram by an angle of less than 10° and at least 0.5° during the pressing process.
